(19) United States
(12) Patent Application Publication
(10) Pub. No.: US 2024/0364230 A1
(43) Pub. Date: Oct. 31, 2024

(54) THREE-PHASE AC/DC CONVERTER AND METHOD FOR OPERATING THE SAME

(71) Applicant: Robert Bosch GmbH, Stuttgart (DE)

(72) Inventors: Dennis Bura, Renningen (DE); Thomas Plum, Koeln (DE)

(21) Appl. No.: 18/646,846

(22) Filed: Apr. 26, 2024

(30) Foreign Application Priority Data
Apr. 27, 2023 (DE) 10 2023 203 895.1

(51) Int. Cl. H02M 7/219; H02M 1/00

(52) U.S. Cl. CPC H02M 7/219; H02M 1/0054

(57) ABSTRACT

A three-phase AC/DC converter and a method for operating a T-type three-phase AC/DC converter with a neutral conductor to an alternating voltage grid for converting a single-phase alternating voltage into a direct voltage. The method includes: switching an input of the third phase to an input of the neutral conductor, and opening a first and a second of the two bridge transistors of the third phase for providing an intermediate switching state between a first charging phase and a second charging phase of the single-phase alternating voltage.

### FIELD

The present invention relates to a three-phase AC/DC converter and to a method for operating a T-type three-phase AC/DC converter with a neutral conductor to an alternating voltage grid. In particular, the present invention relates to a flexible use of a three-phase AC/DC converter and to a design of a three-phase converter that is as cost-effective as possible as well as space-saving and lightweight.

### BACKGROUND INFORMATION

The electrification of individual passenger transport is currently progressing rapidly. A basic distinction can be made between two power supply systems: single-phase alternating voltage and three-phase alternating voltage. While three-phase alternating voltage can provide higher power/energy with slightly more complex hardware, alternating voltage with only one phase and a neutral conductor is much more widely available. Since storing electrical energy in traction batteries requires the alternating voltage to be converted into direct voltage, related-art chargers for electric vehicles are equipped with AC/DC converters.

A circuit of a conventional T-type three-phase AC/DC converter is shown in FIG. 1. The circuit is also referred to as a T-type PFC (power factor correction) circuit. The designation “T-type” results from the T-shaped equivalent circuit diagram of the individual phase modules. The task of this circuit is to draw sinusoidal currents from the three-phase public power supply grid, which is connected to terminals L1, L2, L3, and N, which currents are substantially in phase with the grid voltage and thus ensure a power factor of approximately 1. The electrical power drawn is delivered to the intermediate circuit of the two capacitors shown and is stored there temporarily (buffered). A further circuit portion (not shown here) on the right-hand side then processes the energy further. This circuit portion can, for example, be a galvanic isolation stage, such as an LLC converter, a CLLC converter, or also a dual-active bridge or other circuits. This can also be realized without galvanic isolation.

In comparison to the conventional B6 topology, the T-type PFC circuit advantageously has a third voltage level, which can be connected by activating the two transverse switches for the center tap between the intermediate circuit capacitors. This results in savings in the switching losses of the power semiconductor elements used, since these elements only have to switch against half the intermediate circuit voltage. This can be used to reduce the switching losses and thus to increase the efficiency, and/or the switching frequency can be increased in comparison to the B6 bridge in order thus to achieve savings in the filter components.

If this circuit topology is used as the input stage of an automotive charger, it must additionally be able to cover a number of specific operating states. In particular, this is a single-phase operation with, for example, 7.2 kW for an 11 kW device. For this purpose, two of the three phases are interconnected on the grid side by means of a relay, for example.

The intermediate circuit capacitors C1, C2 shown in FIG. 1 are used to buffer the 100/120 Hz power ripple, which occurs during operation on a single-phase 50/60 Hz grid. This smoothing makes it possible to deliver a constant current to the battery on the output side of the charger.

It proves to be disadvantageous in the T-type PFC circuit that significant currents with 50/60 Hz components occur in the capacitors C1, C2 due to the current flowing back through the neutral conductor (N). This leads to oversizing of the current-carrying capacity and/or capacitance of the capacitors C1, C2 in comparison to the conventional B6 circuit. The intermediate circuit capacitors C1, C2 are typically realized as electrolytic capacitors and are expensive and large components so that oversizing due to the 50/60 Hz current results in a serious disadvantage with installation space requirement and cost expenditure.

FIG. 2 shows the circuit diagram, corresponding to FIG. 1, of selected transistors T1, T2, T7, T8.

FIG. 3 shows the schematic, corresponding to FIG. 1, with a representation of the currents in phase a for the negative half-wave of the grid voltage.

FIG. 4 shows the circuit diagram, corresponding to FIG. 3, of selected transistors T1, T2, T7, T8.

### SUMMARY

It is an object of the present invention to avoid the oversizing of the capacitors of the intermediate circuit due to the single-phase operation, without causing the disadvantages in the design of the rest of the circuit.

According to the present invention, the aforementioned object is achieved by a method with features of the present invention and by a three-phase AC/DC converter with features of the present invention.

Preferred developments of the present invention are disclosed herein.

The method according to the present invention is intended for operating a T-type three-phase AC/DC converter known in principle in the related art, provided that it has a neutral conductor to an alternating voltage grid, which neutral conductor can be connected to a third phase. For this purpose, a relay can be used, for example. The method relates to the use of a T-type three-phase AC/DC converter in conjunction with a single-phase alternating voltage to generate a direct voltage, by means of which a battery of a traction machine of an electrically drivable means of transportation can be charged, for example. In one step according to an example embodiment of the present invention, the third phase is connected on the input side to an input of the neutral conductor in order to compensate for the 50 or 60 Hz ripple produced by the single-phase operation of the other bridges, and a first and a second bridge transistor of the third phase are additionally opened in order to provide an intermediate switching state, which can temporally be between a first charging phase and a second charging phase. This creates an electrical circuit between the two charging phases, which act to charge the intermediate circuit capacitors, the electrical circuit extending via the third phase, two antiseries-connected closed switches (transistors) (FIG. 2, ref. signs T11 and T12), the center tap between the intermediate circuit capacitors, and the neutral conductor and compensating for the current generated by the other bridges. The intermediate switching state can temporally be provided between a first charging phase, which relates to a charging process of a first intermediate circuit capacitor, and a second charging phase, which relates to the charging process of a second intermediate circuit capacitor. The intermediate switching state prevents the bridge transistors assigned to the relevant line/phase from having to switch the entire intermediate circuit voltage, which reduces not only the switching losses but also heat generation in the bridge transistors.

According to an example embodiment of the present invention, preferably, the intermediate switching state can be provided between each charging phase during operation of the converter for converting a single-phase alternating voltage into a direct voltage. In this way, the intermediate circuit voltage to be switched by the bridge transistors is always reduced, approximately halved, for example to 400 V, if a total voltage of 800 V is selected for the intermediate voltage circuit consisting of C1 and C2.

A first intermediate circuit capacitor of the three-phase AC/DC converter can be charged in the first charging phase, and a second intermediate circuit capacitor of the three-phase AC/DC converter can be charged in the subsequent second charging phase. The intermediate circuit capacitors can be interconnected via a center tap, which is also connected to the neutral conductor.

According to an example embodiment of the present invention, charging within the first charging phase and charging within the second charging phase can be clocked at a high frequency, in particular takes place in a pulse-width-modulated manner, in order to make the output-side direct voltage as ripple-free as possible.

An electrical connection between the third phase and the center tap between the intermediate circuit capacitors can in particular be present in the intermediate switching state. This connection can, for example, be made by closing one or both MOSFETs in the horizontal path of the T-type AC/DC converter, which are connected in series in opposite directions. Alternatively, bi-directionally conductive and blocking components may also be used for this purpose.

Preferably, the three phases of the converter, but not the neutral conductor, can have a relevant inductance on the input side and be connected to the alternating voltage grid via the relevant inductance. In a generator, the inductance can also be provided by the windings of the generator (electric machine).

In the following explanation, an electrical connection of the third phase to the intermediate tap during the intermediate switching state is always assumed, which is established by closing two antiseries-connected switches/transistors (FIG. 2, ref. signs T11 and T12). Preferably, in the intermediate phase, a first transistor of the third phase (bridge transistor) can have a switching state identical to a charging phase of a first intermediate circuit capacitor. In other words, the first transistor of the third phase in the intermediate switching state is switched identically to how it is switched in the first charging phase. In addition, the first transistor can be switched in the intermediate switching state in such a way that it corresponds to the preceding intermediate switching state. In other words, the first transistor always has the same switching state in the intermediate phase as in the charging phase of the first intermediate circuit capacitor. Conversely, the second transistor (bridge transistor) of the third phase is preferably in a switching state that is not present during the first charging phase. In particular, both the first transistor and the second transistor (bridge transistors) of the third phase are respectively open (non-conductive) in the intermediate switching state. On the other hand, the first transistor is open (non-conductive) in the first charging state, while the second transistor is closed (conductive) in the first charging state. This applies in particular to the positive half-wave of the alternating voltage. The same can apply in the second charging phase since the open bridge capacitors close the circuit via the inductance of the third electrical phase of the three-phase AC/DC converter.

In particular, according to an example embodiment of the present invention, the intermediate switching state can be shorter, preferably significantly shorter, than the first charging phase and/or the second charging phase. The intermediate state can preferably be selected in the time range of the dead time which is necessary anyway (the time between switching off one switch and switching on the next). Since no intermediate circuit capacitances are to be charged here, but the significantly lower capacitances within the bridge transistors determine the time constant, the duration of the intermediate switching state can be designed independently of the duration of the first charging phase and/or the second charging phase. Instead, the duration of the intermediate switching state must be selected depending on the model used for the bridge transistors. However, in principle, the duration of the first charging phase and/or of the second charging phase can also be used to dimension the duration of the intermediate switching state. In particular, this can involve balancing between the duration of the charging phases and the duration of the intermediate switching state in order to operate the circuit as efficiently as possible.

Preferably, according to an example embodiment of the present invention, the intermediate switching state can respectively have a maximum duration of 0.5 times, in particular 0.1 times, and preferably 0.01 times, the duration of the first charging phase and/or the second charging phase. In practical tests, a duration in the range of several tens of nanoseconds for the intermediate switching state has proven itself for chargers of electrically drivable means of transportation. For example, the duration of the intermediate switching state can be 10 to 80 nanoseconds, preferably 20 to 70 nanoseconds, most preferably 30 to 60 nanoseconds.

According to a second aspect of the present invention, a three-phase AC/DC converter is provided, which is constructed according to the related art, provided that it supports the switching states and switching operations explained above. The three-phase AC/DC converter is configured to perform a method as described in detail above. The features, combinations of features and the resulting advantages obviously correspond to those explained above, such that reference is made to the above statements in order to avoid repetitions.

In particular, a charger for an electrically drivable means of transportation is also proposed, which charger has a three-phase AC/DC converter according to the second-mentioned aspect of the present invention. This charger can be accommodated in electrically drivable means of transportation in a particularly compact, lightweight, cost-effective, and thus mobile manner. Alternatively, the charger can be stationary (e.g., in a wallbox). The method according to the present invention and the included modulation with the intermediate switching state can advantageously also be used with an electric machine in order to reduce the switching losses in the inverter.

### BRIEF DESCRIPTION OF THE DRAWINGS

Exemplary embodiments of the present invention are described in detail below with reference to the figures.

FIG. 1 is a schematic with current phases of a three-phase AC/DC converter for a positive half-wave of the grid voltage according to the related art.

FIG. 2 is a circuit diagram for the schematic shown in FIG. 1.

FIG. 3 is a schematic with current phases of a three-phase AC/DC converter for a negative half-wave of the grid voltage according to the related art.

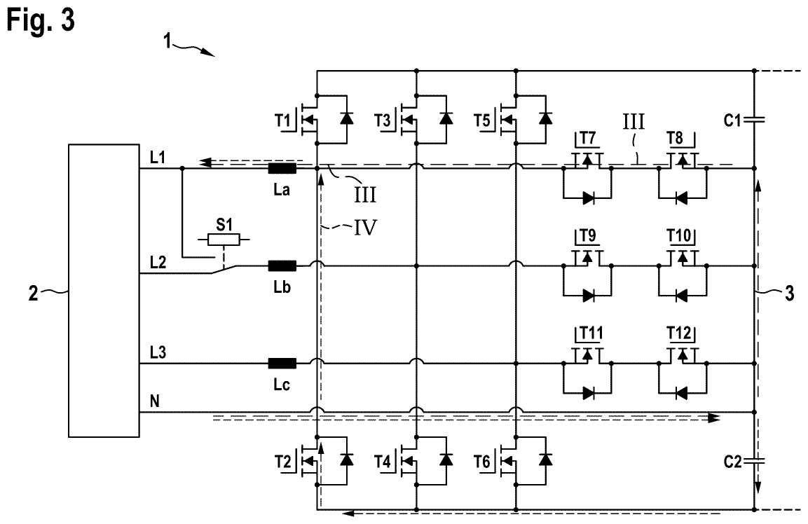

FIG. 4 is a circuit diagram for the schematic shown in FIG. 3.

FIG. 5 is a schematic of a three-phase AC/DC converter illustrating current phases of a single-phase operation with a new operating strategy during a positive grid half-wave of the grid-side alternating voltage, according to an example embodiment of the present invention.

FIG. 6 is a circuit diagram for the schematic shown in FIG. 5.

FIG. 7 is a schematic of a three-phase AC/DC converter illustrating current phases of a single-phase operation with a new operating strategy during a negative grid half-wave of the grid-side alternating voltage, according to an example embodiment of the present invention.

FIG. 8 is a circuit diagram for the schematic shown in FIG. 7.

FIG. 9 is a schematic of a three-phase AC/DC converter, which shows an undesired circular current, which does not contribute to the compensation of switching losses but would produce additional losses.

FIG. 10 is a schematic of a three-phase AC/DC converter designed according to an example embodiment of the present invention, which shows the current paths according to the operating strategy according to an example embodiment of the present invention.

FIG. 11 is a circuit diagram illustrating switching states of four selected transistors for realizing the operating strategy according to the present invention with the intermediate switching state according to the present invention shown in FIG. 10.

### DETAILED DESCRIPTION OF EXAMPLE EMBODIMENTS

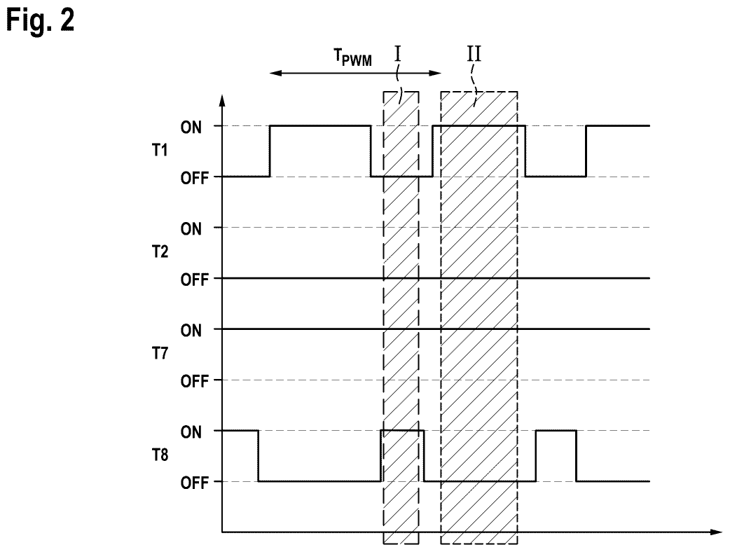

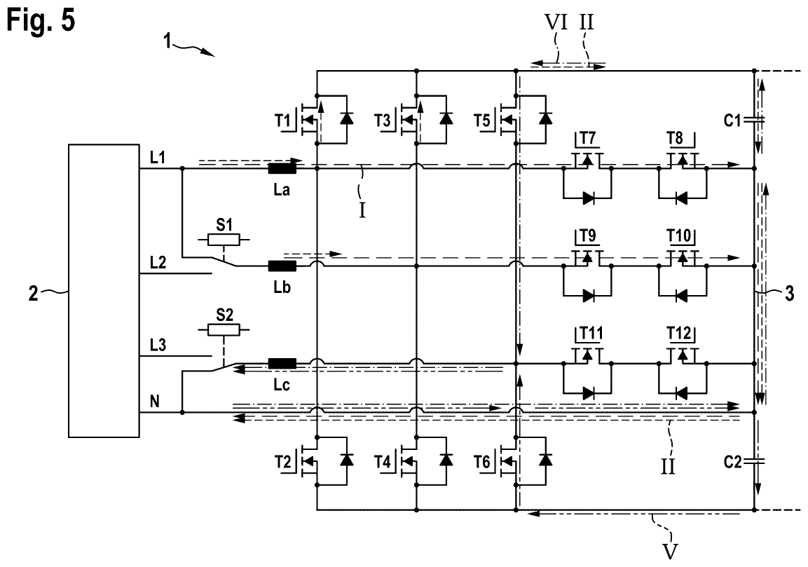

FIG. 5 shows the inventive connection of the three phases L1, L2, L3 for the described single-phase operating state, according to an example embodiment of the present invention. The positive grid half-wave of L1 is considered here, the switching states otherwise corresponding to FIG. 2. The phases L1 and L2 jointly charge the second intermediate circuit capacitor C1. The phase L3 is connected to the neutral conductor N by a switch S2 (e.g., a relay) and compensates for a portion of the current through the second intermediate circuit capacitor C1. The phase current in L3 can be adjusted by conventional control methods (e.g., PI controller, resonant controller, etc.) such that the 50 Hz current of the neutral conductor N can flow back through the phase L3 so that the intermediate circuit capacitors C1, C2 are no longer or no longer significantly loaded by this proportion of the current. This makes it possible to design the expensive intermediate circuit capacitors C1, C2 exclusively for the 100/120 Hz ripple and to eliminate the disadvantage of this circuit in comparison to the conventional B6 bridge (not shown).

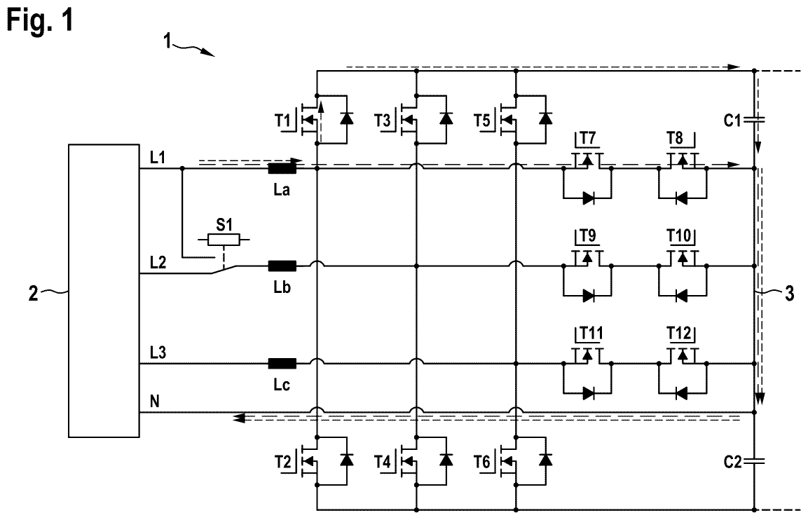

The three-phase currents provide approx. 7.2 kW in a single-phase operation. While the current phases I, II correspond to FIG. 1, the first intermediate circuit capacitor C2 is charged in current phase V and the second intermediate circuit capacitor C1 is discharged in the subsequent current phase VI. The current shown acts as a discharge current with respect to the intermediate circuit capacitor C1. Overall, C1 is nevertheless charged since the proportion of the current through the transistors T1 and T2 is greater than the current generated by the intermediate switching state. The first current phase I, on the other hand, runs via the node 3 into the neutral conductor N.

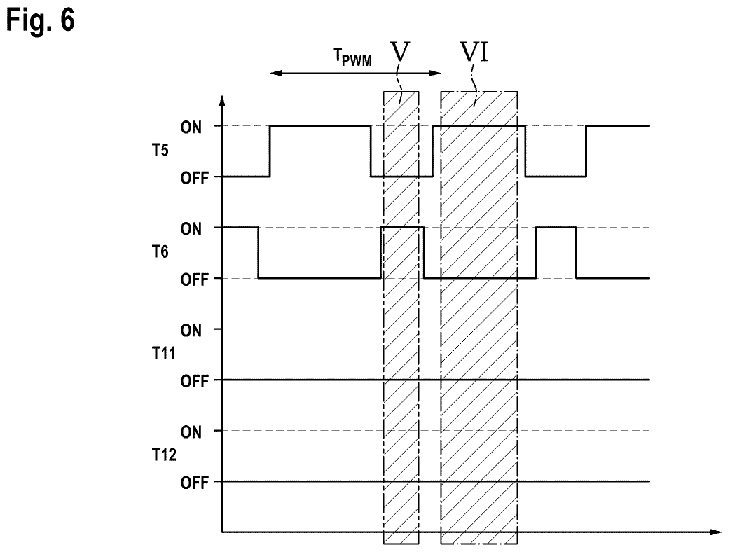

FIG. 6 shows the switching state diagram associated with FIG. 5, which shows the first charging phase V and the second charging phase VI. The pulse width modulation (PWM) of the cycle is also indicated. With the duration of the cycle, the charging phases are also adapted in terms of their duration, as is conventional in the related art.

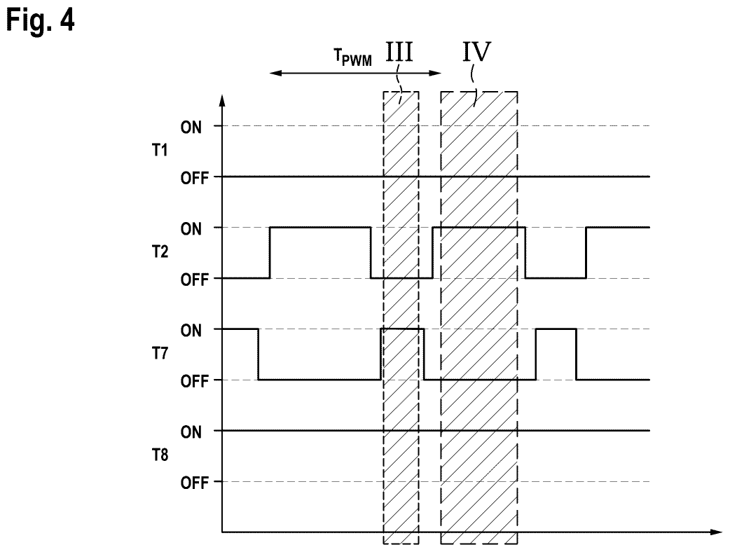

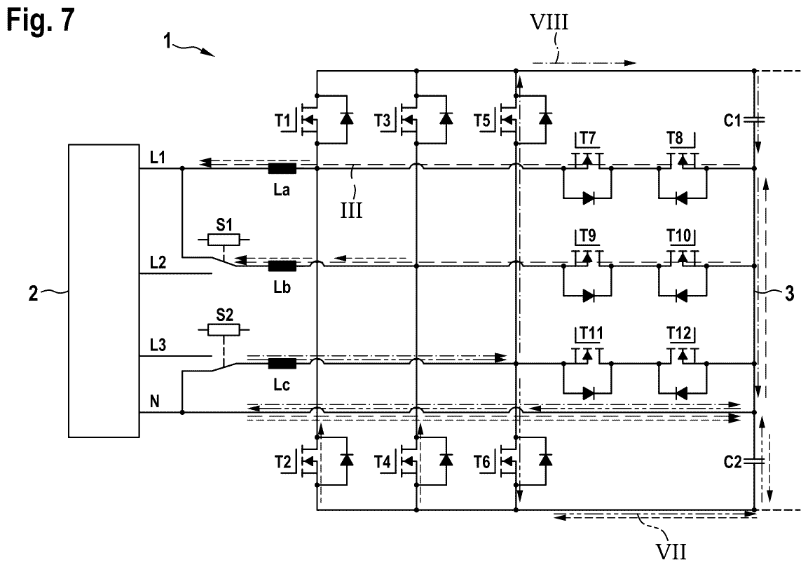

FIG. 7 shows the circuit diagram shown in FIG. 5, for a negative grid half-wave of the first phase L1, with the switching commands according to FIG. 4 for the third current phase III and the fourth current phase IV. The seventh current phase VII is now added for charging the first intermediate circuit capacitor C2, and the eighth current phase VIII is added for charging the second intermediate circuit capacitor C1. The first two phases of the converter 1 charge C2. The third phase of the converter 1 is connected to N via S2 and compensates for a portion of the current through the first intermediate circuit capacitor C2.

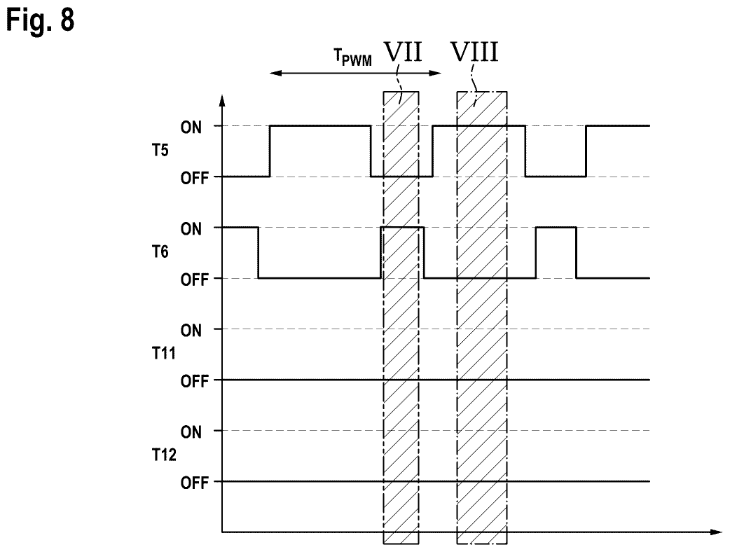

FIG. 8 shows the switching state diagram of the drawing presented in FIG. 7.

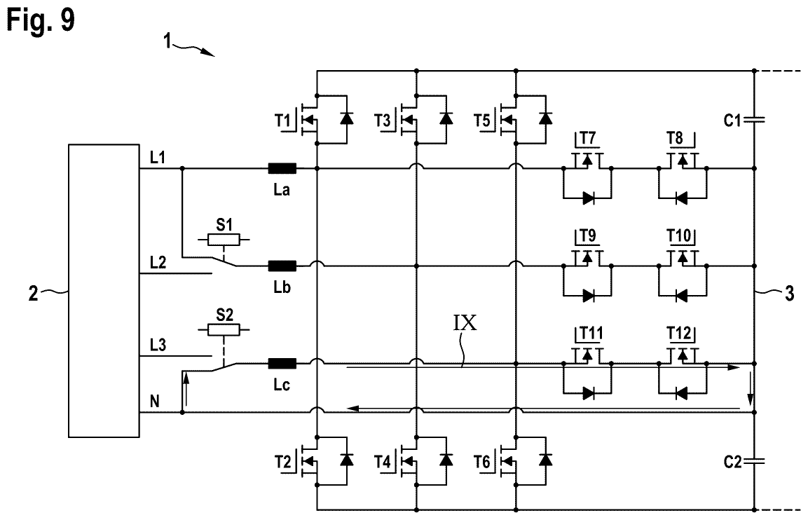

FIG. 9 shows a circuit diagram of a three-phase AC/DC converter 1, in which an undesired current phase IX is shown as a circular current, which does not contribute to the compensation but would produce additional losses and must therefore be prevented. The third phase of the three-phase AC/DC converter must not be switched in normal 3-level operation since a significant portion of the current would flow through the transistors T11, T12 in this case. A conventional 2-level PWM is therefore used. However, this PWM has the disadvantage that the full intermediate circuit voltage must be switched via both intermediate circuit capacitors C1, C2 when switching the bridge transistors T5, T6. This leads to higher losses, which is why the switching frequency must be reduced. However, a reduced switching frequency leads to increased ripples, which in turn is disadvantageous for the design of the inductance Lc and further filter components (not shown).

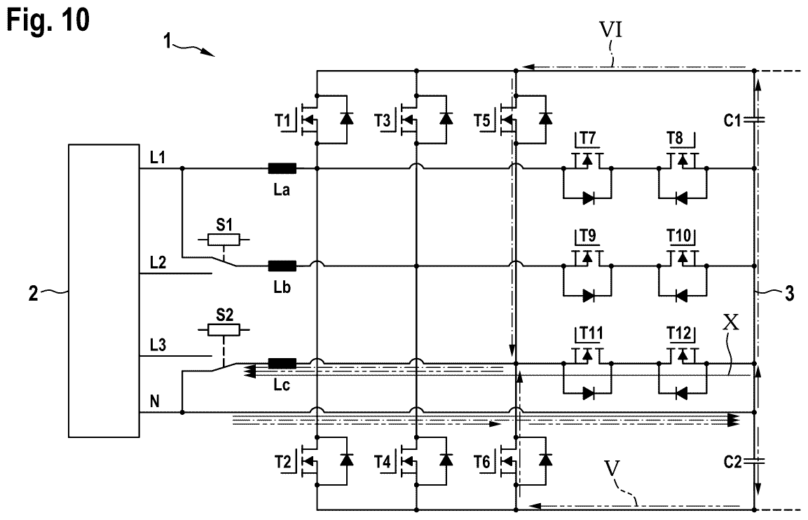

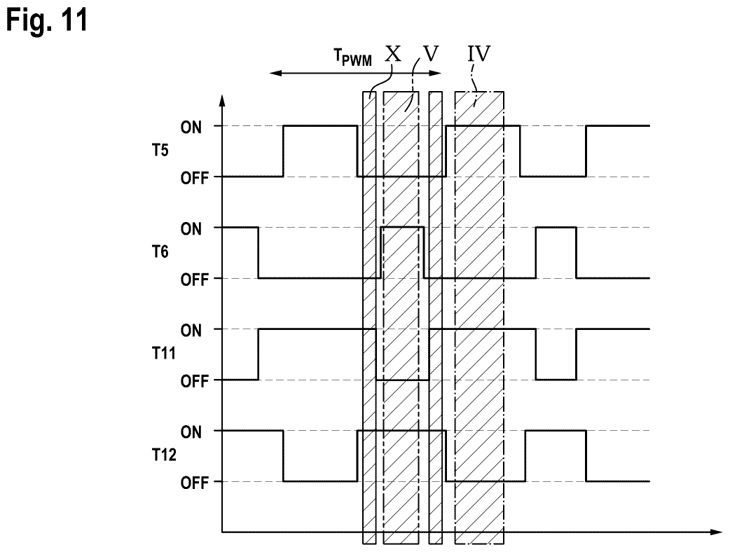

FIG. 10 shows a circuit diagram of a three-phase AC/DC converter 1 designed according to the present invention, the operating strategy of which is explained with reference to the circuit shown in FIG. 5. The phases V and VI correspond to those in FIG. 5. In other words, the positive half-wave is converted via L1. A new feature is the modulation, for which reference is made to FIG. 11. Between a change from the fifth current phase V to the sixth current phase VI (and vice versa), the tenth current phase is connected as an intermediate switching state X. The transistors T5, T6 now no longer switch the entire voltage applied across the intermediate circuit capacitors C1, C2, but in each case only the output-side voltage applied across the respective intermediate circuit capacitors C1, C2 up to node 3. This reduces the switching losses in the transistors T5, T6. As a result, the switching frequency for providing the output-side direct voltage can be increased and the ripple can be reduced. Accordingly, the inductances La, Lb, Lc and the intermediate circuit capacitors C1, C2 can also be dimensioned more favorably.

1-11. (canceled)

12. A method for operating a T-type three-phase AC/DC converter with a neutral conductor to an alternating voltage grid for converting a single-phase alternating voltage into a direct voltage, the method comprising the following steps:
switching an input of a third phase to an input of the neutral conductor; and
opening a first and a second of two bridge transistors of the third phase and closing at least one transverse switch for providing an intermediate switching state between a first charging phase and a second charging phase of the single-phase alternating voltage.

13. The method according to claim 12, wherein the intermediate switching state is provided between each charging phase during operation of the converter.

14. The method according to claim 12, wherein the first charging phase includes charging a first intermediate circuit capacitor of the converter and the second charging phase includes charging a second intermediate circuit capacitor.

15. The method according to claim 14, wherein an electrical connection between an input of the third phase and a node between the first and second intermediate circuit capacitors is present in the intermediate switching state.

16. The method according to claim 12, wherein the three phases of the converter have a relevant inductance in their input and are connected via the relevant inductance to the alternating voltage grid.

17. The method according to claim 12, wherein the intermediate switching state is such that a first transistor of the third phase has a switching state identical to a charging phase for charging a first intermediate circuit capacitor, a second transistor of the third phase has a switching state identical to a charging phase of a second intermediate circuit capacitor, while two transverse switches connecting the third phase to a center tap of the three-phase AC/DC converter are switched to conductive.

18. The method according to claim 12, wherein the intermediate switching state is shorter than the first charging phase and/or the second charging phase.

19. The method according to claim 12, wherein the intermediate switching state: (i) is independent of a duration of the first charging phase and/or the second charging phase, or (ii) is selected depending on the duration of the first charging phase and/or the second charging phase.

20. The method according to claim 12, wherein the intermediate switching state has in each case a maximum duration of 0.5 times a duration of the first charging phase and/or the second charging phase.

21. A T-type three-phase AC/DC converter with a neutral conductor to an alternating voltage grid for converting a single-phase alternating voltage into a direct voltage, the converter configured to:
switch an input of a third phase to an input of the neutral conductor; and
open a first and a second of two bridge transistors of the third phase and close at least one transverse switch for providing an intermediate switching state between a first charging phase and a second charging phase of the single-phase alternating voltage.

22. A three-phase inverter configured to supply electrical energy to an electric machine by:
switching an input of a third phase to an input of a neutral conductor; and
opening a first and a second of two bridge transistors of the third phase and closing at least one transverse switch for providing an intermediate switching state between a first charging phase and a second charging phase of the single-phase alternating voltage.
